(19) United States
(12) Patent Application Publication
(10) Pub. No.: US 2018/0300035 A1
(43) Pub. Date: Oct. 18, 2018

(54) Visual cues for scrolling

(71) Applicant: Viktor Kaptelinin, Hornefors (SE)

(72) Inventor: Viktor Kaptelinin, Hornefors (SE)

(21) Appl. No.: 15/956,745

(22) Filed: Apr. 19, 2018

Related U.S. Application Data
(63) Continuation-in-part of application No. 14/812,123, filed on Jul. 29, 2015, now abandoned.
(60) Provisional application No. 62/030,437, filed on Jul. 29, 2014.

(51) Int. Cl. G06F 3/0485; G06F 3/0488; G06F 9/451

(52) U.S. Cl. CPC G06F 3/0485; G06F 9/453; G06F 3/0488

(57) ABSTRACT

The invention discloses a method and apparatus for helping the user of computer devices, such as desktop computers, laptop computers, tablet computers, smartphones, and augmented reality devices, to view information displayed during and after scrolling, when scrolling is performed with variable increment scrolling input devices, such as scroll wheels or touch-sensing devices. According to an embodiment of the invention, the area of the displayed document, which corresponds to either the location of the screen pointer immediately before scrolling or the point of the initial user contact with a touchscreen, is highlighted with visual cues during and shortly after scrolling to support the continuity of user's attention.

### CROSS-REFERENCE TO RELATED APPLICATIONS

The present application is a continuation-in-part of U.S. Patent Application Ser. No. 14/812,123, filed Jul. 29, 2015 with title “VISUAL CUES FOR SCROLLING” and naming Viktor Kaptelinin as inventor, which claims the benefit of provisional U.S. Patent Application Ser. No. 62/030,437, filed Jul. 29, 2014 with title “VISUAL CUES FOR SCROLLING” and naming Viktor Kaptelinin as inventor. All of the foregoing applications are hereby incorporated herein by reference in their entirety.

### FEDERALLY SPONSORED RESEARCH

Not Applicable

### 1. BACKGROUND OF THE INVENTION

The invention relates to user interfaces of computing devices, such as desktop computers, laptop computers, tablet computers, smartphones, electronic bookreaders, and so forth.

Computing devices having screens typically display various visual contents in windows, that is, dedicated viewing areas of a screen. In the context of this invention the term “window” is understood in a broad sense, as a content viewing area of any displays, including displays of tablet computers, smartphones, bookreaders, and embedded systems.

Only a portion of a window-related content, such as a document, may be displayed in a window, and the user may need to scroll the window to see other portions of the content. Many modern computing devices support variable increment scrolling, for instance, scrolling by using a scroll wheel of a computer mouse or by performing multi-touch gestures (e.g., panning or quick “flicking”) on touch-sensing input devices, such as touchpads or touchscreens. When using a scroll wheel, touch pad, or touchscreen, the user can decide on a moment-to-moment basis how much scrolling is to be achieved by a certain scroll action.

Three types of variable increment scrolling, known in prior art, are shown in FIGS. 1-3. FIG. 1a schematically depicts window 100, which is displaying portion 103 of its content, before the user scrolls window 100 by rolling up a scroll wheel 150, said scroll wheel being a part of mouse 160. FIG. 1b depicts window 100, which is displaying portion 105 of its content, after the user scrolls window 100 by rolling a scroll wheel 150 up. Portion 105 contains two lines 107, which are are not contained in portion 103. FIGS. 1a and 1b also show screen pointer 120.

Scrolling a window changes the location of objects displayed in the window (thereafter, “display location”). For instance, the scrolling action illustrated by FIG. 1a and FIG. 1b changes the display location of letter sequence 125 (“tation”) so that said sequence is displayed higher in the window. Some objects, such as the first two lines of portion 110 (FIG. 1a), may become not visible after scrolling.

Display locations of an object shown in a window can be described, for instance, by window coordinates of the point generally corresponding to the geometrical center of the area displaying the object. For instance, the change of the display location of letter sequence 125, shown in FIG. 1a and FIG. 1b, can be described as a change of the window coordinates of the point generally corresponding to the geometrical center of the area displaying sequence 125 from “x, y1” to “x, y2”. It should be noted that the scroll action shown in FIG. 1a and FIG. 1b only involves vertical scrolling, so that only the “y” window coordinate is changing. If a scroll action has both vertical and horizontal components, as in case of oblique scrolling, both “x” and “y” coordinates of screen objects will change.

FIG. 2 depicts a scroll action similar to the one depicted in FIG. 1, with a difference that the scroll action depicted in FIG. 2 is achieved by performing a panning gesture when using a touch pad. The user moves two fingers while maintaining contact with a touchpad, so the displayed content moves in the respective direction as long as the contact is not interrupted. FIG. 3 depicts scrolling caused by performing a flicking gesture, which includes kinetic scrolling, when using a touch-sensing device integrated with a display, namely, a touchscreen. Kinetic scrolling in this case is a type of scrolling when the content of a window continues to move after the contact between user's finger 300 and the touch-sensing device is terminated, as if the scrolled image had physical inertia. The scrolling movement eventually slows down and stops; the speed of kinetic scrolling and the distance over which the content moves before it stops depend on the speed of the movement of users' finger.

Prior art depicted in FIGS. 1-3 shows that machine-comprised means for detecting scrolling user actions, such as panning or kinetic scrolling, are known in prior art and implemented in existing products.

By employing the aforementioned devices users can perform variable-increment scrolling actions more directly, without using a separate graphical user interface (GUI) widget, such as a scroll bar. However, there is a problem with variable increment direct scrolling, especially when a separate touch-sensing device is used or the flicking gesture is executed to cause kinetic scrolling. Changing display locations of objects displayed in a window, especially if the change is fast, may make it difficult for the user to maintain the continuity of attention to the content displayed in the window. As a result, users may “loose their place” on a display: users' attention can be disrupted, orientation lost, and the user may need to scan the new, post-scroll image, to ensure the continuity of attention after scrolling.

Prior art teaches visual cues that can be used to mitigate or eliminate the problem of “loosing one's place” on a page after scrolling, for instance, by visually separating old and new content. However, these teachings do not provide sufficient support for dealing with attention interruptions caused by variable increment scrolling.

### 2. SUMMARY OF THE INVENTION

The present invention takes advantage of the fact that when the user initiates a scrolling action there is often a particular area of the display, which is selected by the user. If a separate input device is used, there is typically a screen pointer directed at a certain point of the screen. If a touch sensitive display (“touchscreen”) is used, the user touches the display at a certain area. In either case the user, explicitly or implicitly, points to an area of the document shown on the display. In the context of the present invention this area of the document is referred to as “reference document area”. The proposed solution to supporting the continuity of user's attention, disclosed by the invention, is based on the assumption that visual cues generally continuously highlighting the reference document area during scrolling will allow the user to visually perceive, assess, and, if necessary, adjust the scrolling distance and thus more efficiently maintain the continuity of attention when viewing the content presented during or after scrolling.

More specifically, the invention teaches visual cues that during and generally immediately after scrolling generally continuously highlight a “reference document area”, which is defined as an area of the displayed document, which is displayed generally at the “initial display location”. “Initial display location”, in turn, is defined as the location selected by the user through a pointing action when the user initiates a scrolling action. Initial display location can be either: (a) the screen location of the initial contact of the user with a touchscreen when performing a scrolling action, if the scrolling action is performed through a touchscreen gesture, or (b) the screen location of the screen pointer immediately before a scrolling action when a separate device different from the screen, such as a scroll wheel or touchpad, is used. When a window scrolls, the reference document area is displayed in other screen areas than the initial display location. For instance, FIG. 1 shows how the reference document area essentially corresponding to letter sequence 125, which sequence is displayed generally at the initial display location (that is, screen location of pointer 120 immediately before the scrolling, FIG. 1a) changes its display location and is displayed after scrolling higher in window 110 (FIG. 1b).

In some embodiments of the invention a method is disclosed for assisting a user of an electronic device in viewing information on said electronic device, said electronic device having at least a processor, a memory storage, said memory storage can be integrated with said processor, a variable increment scrolling input device, a display, said display having an at least a window displaying a portion of at least a document, and means for detecting a location of said display selected through a pointing user action, the method comprising the method steps of:

detecting a first scrolling user action; and

creating a computer memory description of a reference area of said document, said reference document area being a document area displayed at generally an initial display location, said initial display location being a location of said display selected through a pointing user action at a moment when the first scrolling user action is detected; and

scrolling said display window from a first portion of said document to a second portion of said document, wherein generally continuously providing a first visual cue for highlighting said reference document area.

Another embodiment of the above method further comprises disabling said first visual cue after a first predetermined amount of time.

In other embodiments the above method a separate input device is used for scrolling, the user is provided with means for controlling a screen pointer; and said initial display location is a screen location of a screen pointer at a moment when the first scrolling user action is detected.

In yet another embodiment the above method further comprises the method steps of detecting a second scrolling user action; and

if an amount of time between the first scrolling user action and the second scrolling user action is less than a second predetermined amount of time, then scrolling the display window to a third portion of said document, wherein generally continuously providing the first visual cue for highlighting said reference document area as long as said reference document area is visible in said display window, and

disabling said first visual cue after a third predetermined amount of time.

In some embodiments the above method further comprises the step of generally continuously providing a second visual cue for highlighting a distance between said reference document area and said initial display location.

In other embodiments of the above method the first visual cue is disabled by gradually fading away.

In some embodiments of the above method the presence or absence, size, shape, color, and transparency of the first visual cue, as well as a spatial offset between the initial display location and the first visual cue, can be defined or selected by the user.

In yet another embodiment of the above method a touch-sensitive display is used as a scrolling input device, and said initial display location is a screen location of user's contact with the touch-sensitive display at a moment when the first scrolling user action is detected.

In some embodiment of the above method the scrolling of said display window from the first portion of said document to the second portion of said document includes scrolling that temporarily continues when user's contact with the display is terminated, and in some embodiments of this method the first visual cue is not displayed when user's contact with the touchscreen display is maintained.

In some embodiments an apparatus is disclosed, comprising at least

a processor,

a memory storage, which can be integrated with said processor,

a variable increment scrolling input device, such as a scroll wheel or a touch-sensing device,

a display, which can be integrated with said input device, for instance, in the form of a touch-sensitive display, said display including at least a window displaying a portion of at least a document,

software for detecting a first scrolling user action, said scrolling user action detection software stored in said memory storage,

software for detecting a screen area of said display selected through a pointing user action,

software for detecting an initial display location, said initial display location being an area of said display selected through a pointing user action at a moment when the first scrolling user action is detected,

software for defining a reference document area as an area of said document displayed at generally said initial display location at the moment when the first scrolling user action is detected, said reference document area defining software stored in said memory storage,

software for enabling the scrolling of said display from a first portion of said document to a second portion of said document, wherein generally continuously providing a first visual cue for highlighting the reference document area, said scrolling enabling software stored in said memory storage, and

software for disabling said third visual cue after a first predetermined amount of time, said visual cue disabling software stored in said memory storage.

In another embodiment of the invention the above apparatus further comprises a separate scrolling input device, software for establishing the location of a screen pointer at a moment when the first scrolling user action is detected, and software that defines said screen pointer location as the initial display location.

In yet another embodiment of the invention the above apparatus further comprises a touch-sensitive display used to perform scrolling, software for establishing the location of a screen location of user's contact with the display at a moment when the first scrolling user action is detected, and software that defines said screen contact location as the initial display location.

In some embodiments of the invention the above apparatus further comprises

software for detecting a second scrolling user action, said detecting software stored in said memory storage,

software for deciding whether the amount of time between the first user action and the second user action is less than a second predetermined amount of time, said deciding software stored in said memory storage,

software for enabling the scrolling of said display to a second portion of said document, wherein generally continuously providing a first visual cue for highlighting the reference document area as long as said reference document area is visible on said display, said scrolling software stored in said memory storage,

software for disabling said first visual cue after a third predetermined amount of time.

### 3. BRIEF DESCRIPTION OF THE DRAWINGS

FIGS. 1a-1b illustrate a prior art method of scrolling with a scroll wheel.

FIGS. 2a-2b illustrate a prior art method of scrolling with a touch-sensing device, such as touch pad.

FIGS. 3a-3c illustrate a prior art method of scrolling by performing a flicking gesture on a touch screen.

FIGS. 4a-4c illustrate the input device and GUI display according to some embodiments of the invention.

FIGS. 5a-5b illustrate the input device and GUI display according to some embodiments of the invention.

FIGS. 6a-6c illustrate the input device and GUI display according to some embodiments of the invention.

FIGS. 7a-7c illustrate the input device and GUI display according to some embodiments of the invention.

FIGS. 8a-8c illustrate the input device and GUI display according to some embodiments of the invention.

FIGS. 9a-9b illustrate the input device and GUI display according to some embodiments of the invention.

FIGS. 10a-10d illustrate the input device and GUI display according to some embodiments of the invention.

FIGS. 11a-11d illustrate the input device and GUI display according to some embodiments of the invention.

FIGS. 12a-12d illustrate the input device and GUI display according to some embodiments of the invention.

FIGS. 13a-13d illustrate the input device and GUI display according to some embodiments of the invention.

FIGS. 14a-14e illustrate the input device and GUI display according to some embodiments of the invention.

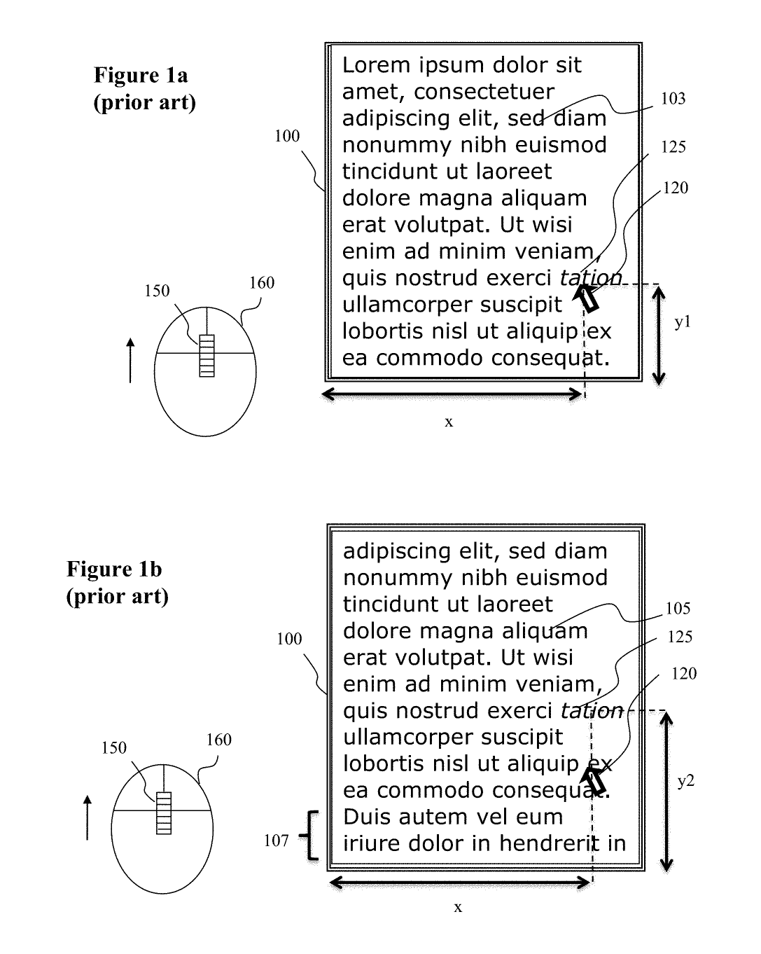

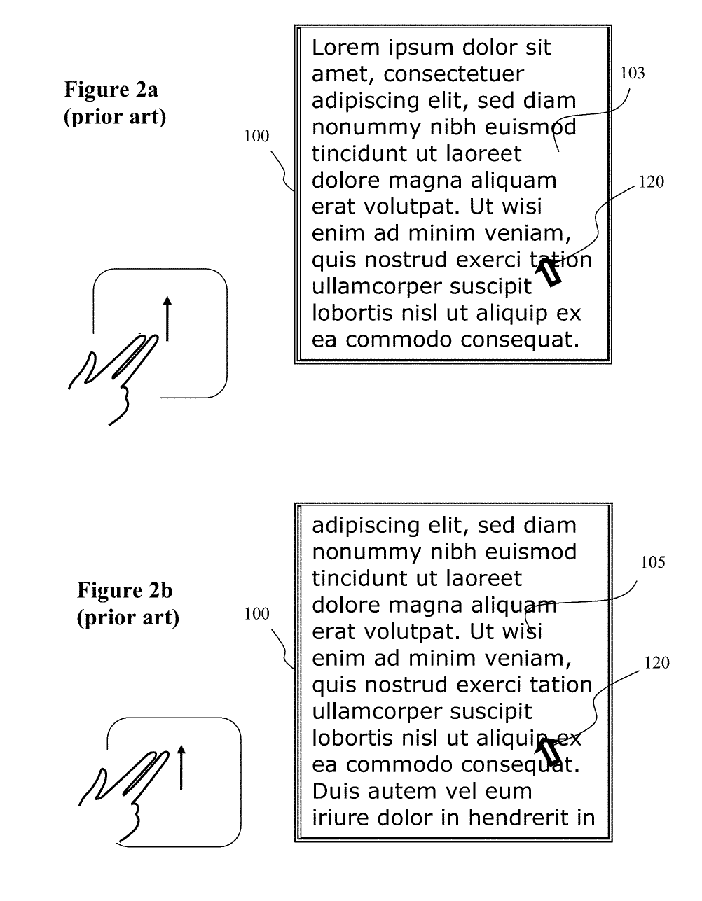

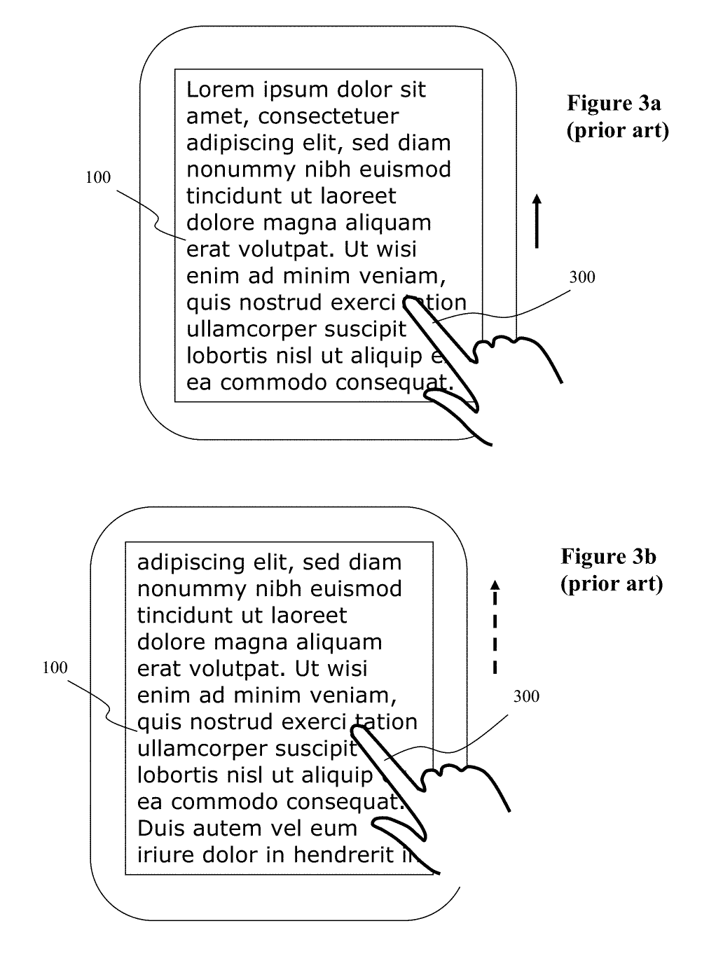

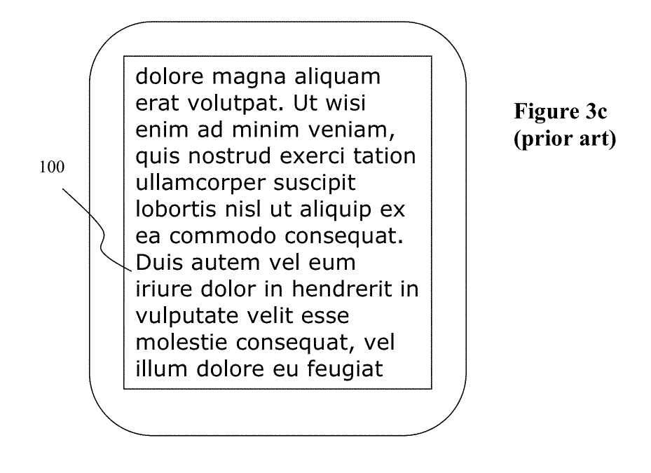

### 4. DETAILED DESCRIPTION OF THE INVENTION

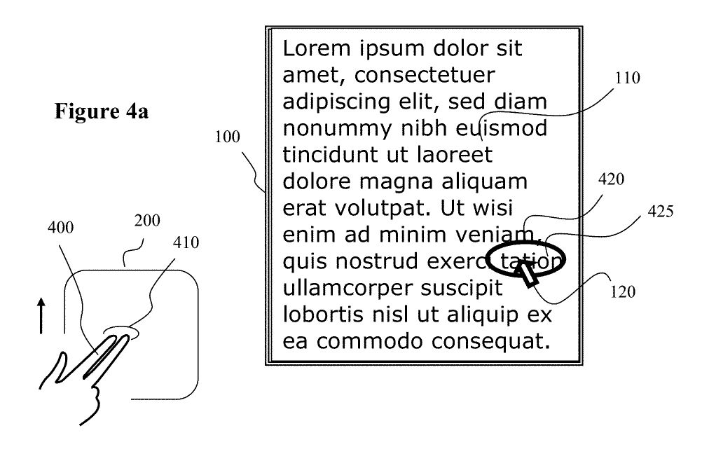

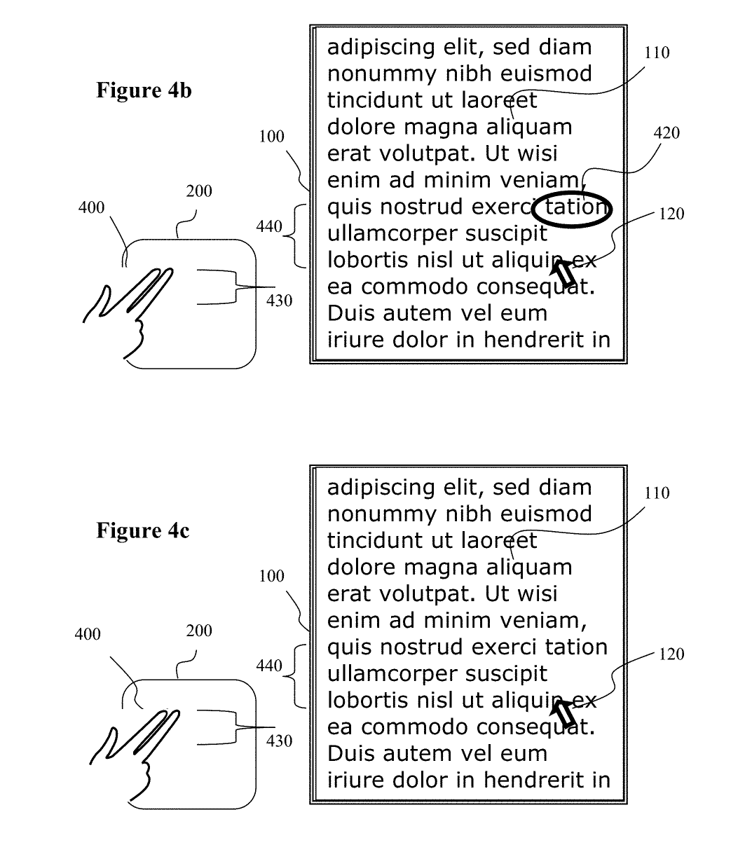

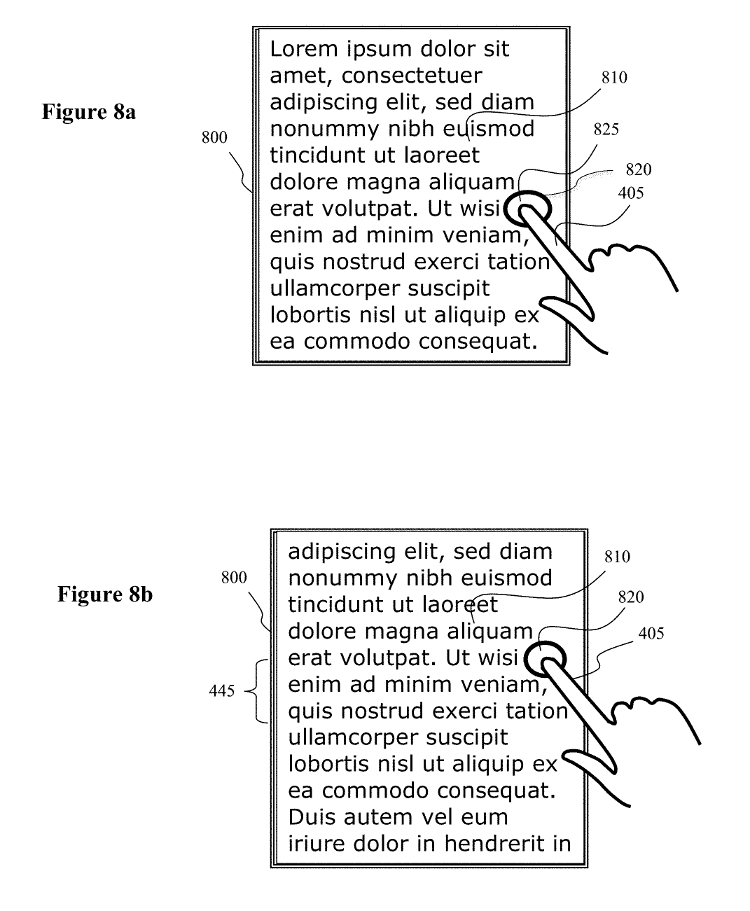

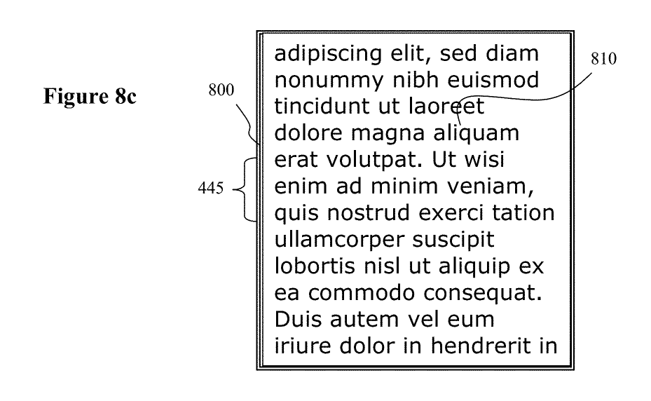

The first embodiment of the invention, illustrated by FIGS. 4-11, discloses a method and apparatus for “panning”, that is, scrolling that is only performed as long as the user maintains contact with a scrolling input device. Two variations of the first embodiment are illustrated by FIGS. 4-11: (a) using a separate touch-sensing device, such as touchpad, as a scrolling input device (FIGS. 4-8), and (b) using a touch-sensitive display that can be used for both content viewing and scrolling, thereafter “touchscreen” or “touchscreen display” (FIGS. 8-11). The user makes an initial contact with the device, for instance, with a finger, two fingers, or a stylus, and then moves the contact area, while maintaining a continuing contact with the device, away from the initial contact area, so that the direction and distance of the scrolling are determined by the direction and distance of user's movement from the initial contact area to a new contact area. No scrolling takes place when the contact between user's finger, fingers, stylus, or other object used for scrolling, on the one hand, and the touch-sensing device, on the other hand, is interrupted.

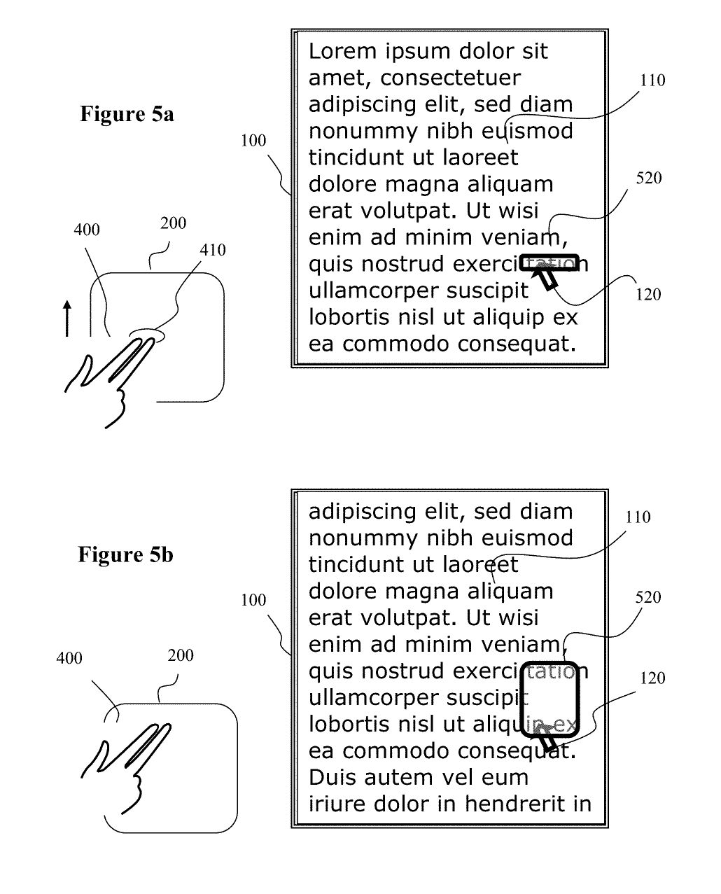

The first variation of the first embodiment is illustrated by FIGS. 4-8. FIG. 4a shows a window 100 that displays a portion of window-related content, that is, document 110. Document 110 is scrolled by using a separate touch-sensing device 200. User's fingers 400 make initial contact with the touch-sensing device 200 in an area 410. The initial screen location of a pointer 120 in window 100 in the beginning of scrolling (when the scrolling action is detected, which is assumed to be the moment when the scrolling action is initiated by the user)), that is, initial display location, defines a reference document area 425 of document 110. Area 425 generally corresponds to the area of document 110 generally displayed around the initial screen location of pointer 120 at the moment when the scrolling action is detected. In FIG. 4a area 425 is depicted as a generally oval area, the geometrical center of which is the initial screen location; the area generally corresponds to a letter sequence “tation”). Visual cue 420 is a generally oval screen artefact, which is displayed in window 100 to highlight reference document area 425. As shown in FIG. 4b, when user's fingers 400 move up for distance 430, document 110 scrolls up for distance 440, and reference document area 425 highlighted by visual cue 420 also moves up for distance 440 (FIG. 4b). Visual cue 420 is disabled after a predetermined amount of time (FIG. 4c). It should be noted that various sizes and shapes of reference document areas defined by an initial screen location (e.g., a circle, an oval, a rectangle, or another geometrical shape with an initial screen location being its geometrical center), as well as various types of visual cues (e.g., spots of various size, shape, color, brightness, and transparency, a highlighted line of text) are covered by the invention. All such variations, obvious to those skilled in the art, are within the scope of the present invention. One such variations, for instance, is an elongated screen artefact 520 displayed generally between an initial display location and a current screen location of reference document area during and immediately after scrolling (FIG. 5).

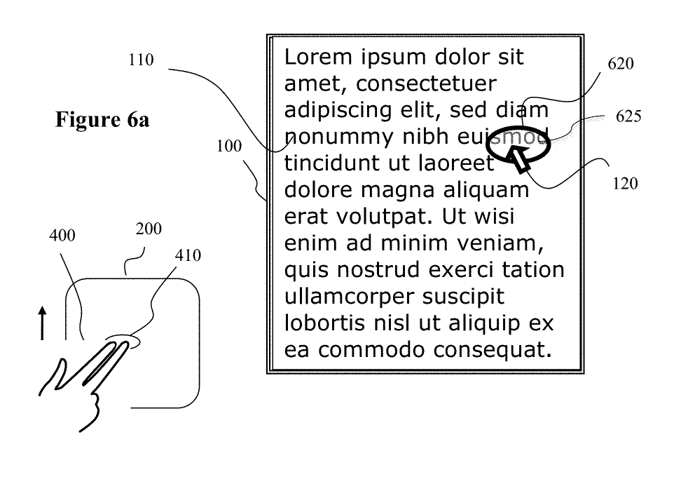

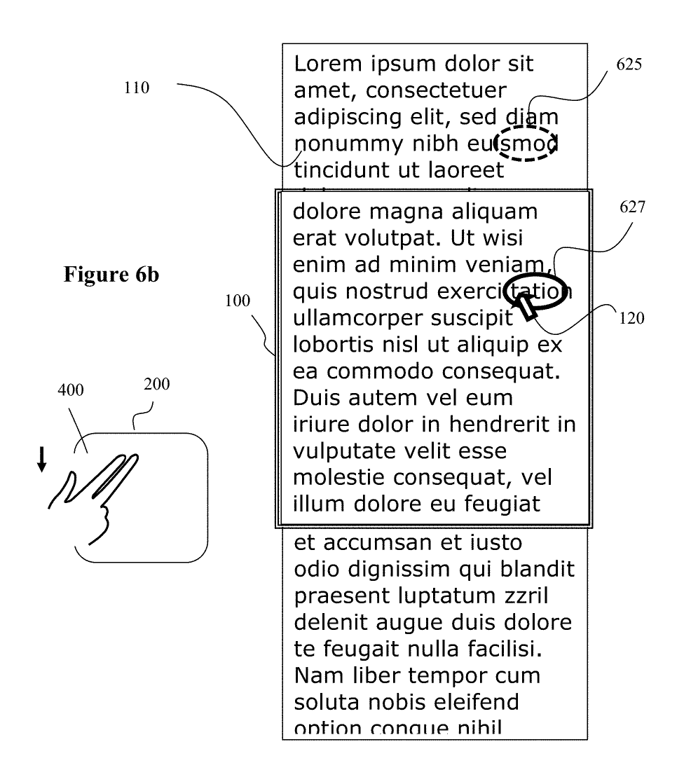

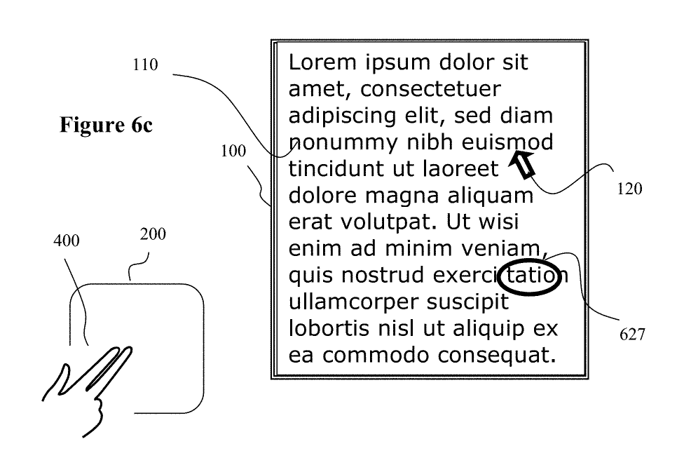

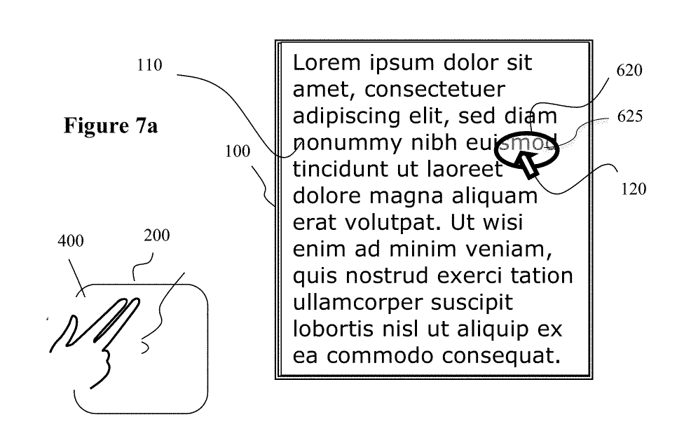

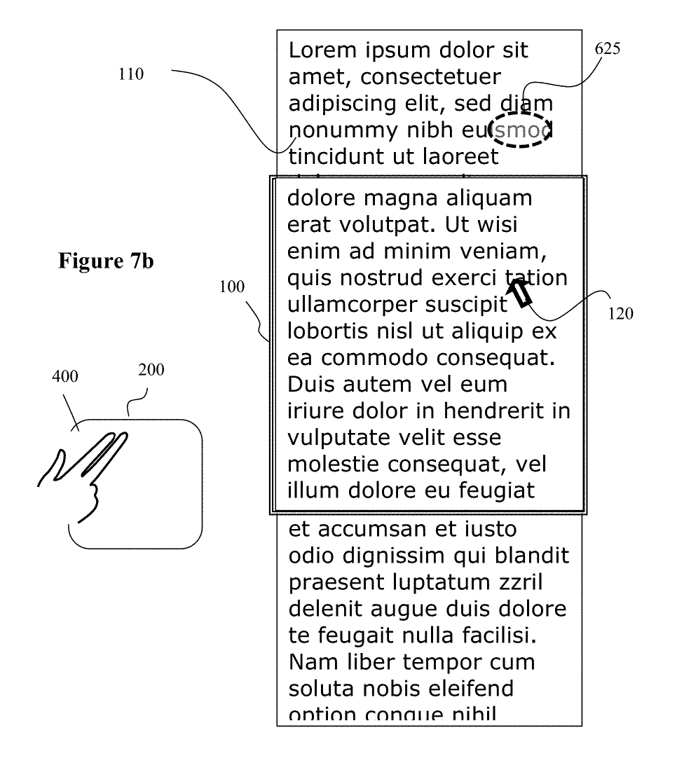

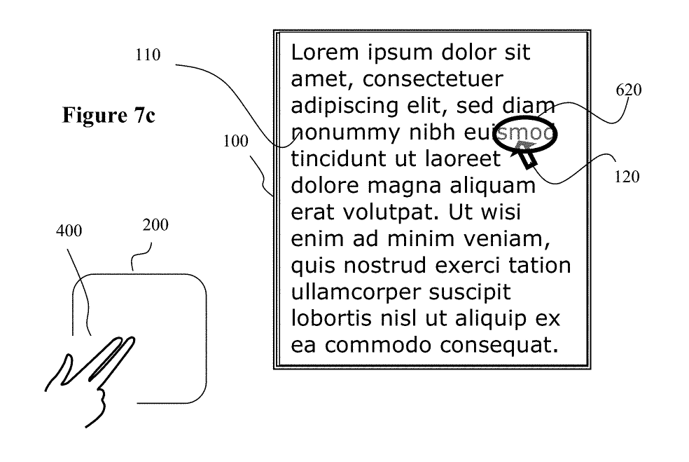

The visual cue disclosed in the present invention can be disabled when a scrolling action is completed, either immediately or after a predetermined amount of time. However, if a new scrolling action is initiated generally shortly after the previous scrolling action, then the visual cue from the previous scrolling action can be used instead of generating a new visual cue. This variation of the first embodiment is illustrated by FIG. 6 and FIG. 7. FIG. 6 depicts a sequence of two scrolling actions, first scrolling up and then scrolling down by generally the same distance, with the second scrolling action taking place after more than a predetermined amount of time after the first scrolling action is completed. The first action (FIG. 6a and FIG. 6b) produces a visual cue 620 and moves the cue, along with its corresponding reference document area 625, outside the display limits, which renders visual cue 620 invisible. The second scrolling action (FIG. 6b and FIG. 6c) produces a new visual cue 6275. When the second scrolling action is completed, cue 627 moves to a screen location below pointer 120. FIG. 7 depicts a sequence of two scrolling actions, scrolling up and then scrolling down by generally the same distance, with the second scrolling action taking place after less than a predetermined amount of time after the first scrolling action. The first action (FIG. 7a and FIG. 7b) produces a visual cue 620 and moves the cue, along with its corresponding reference document area 625, outside the display limits, which renders visual cue 620 invisible. The second action (FIG. 7b and FIG. 7c) brings visual cue 620 back to window 100 rather than producing a new visual cue. The present variation of the first embodiment also applies to cases when the first visual cue does not move outside the display limits, and therefore is always visible. The variation also applies to cases when several scrolling actions take place after one another, each less then a predetermined amount of time after the previous one; in such cases the first visual clue will be displayed after several scrolling actions.

An obvious variation of the first embodiment, which variation is shown in FIGS. 8-11, involves a panning scrolling action performed on a touchscreen. In that case users commonly employ a one-finger gesture and the direction and distance of the scrolling are the same as the direction and distance of the movement of user's finger (or of another object or objects used by the user) from the initial contact point to a new contact point. Otherwise the visual cue is used in generally the same manner as described in FIG. 4.

FIG. 8a shows a touchscreen display 800 that displays a portion of document 810. Reference document area 825 is an area of document 810 that is displayed generally around the initial display location, that is, the location of the contact of user's finger 405 with display 800 at the moment when the scrolling action is initiated by the user (which is assumed to be the same as the moment when the scrolling action is detected). In FIG. 8a area 825 is depicted as a circle, the geometrical center of which is the initial screen location; the area generally corresponds to an area of document 810 located to the right of letter sequence “wisi”. Visual cue 820, a circle generally corresponding to document reference area 825, is displayed to highlight reference document area 825. As shown in FIG. 8b, when user's finger 405 moves up for distance 445, document 810 scrolls up for the same distance, and reference document area 825 highlighted by visual cue 820 also moves up for distance 445 (FIG. 8b). Visual cue 820 is disabled after a predetermined amount of time (FIG. 8c).

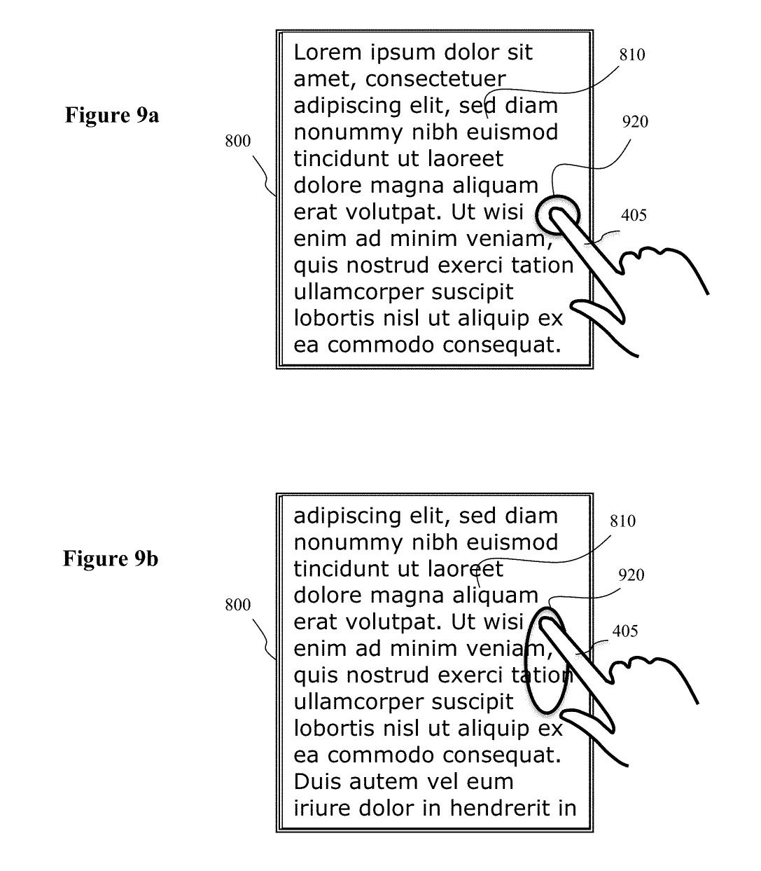

FIG. 9 depicts a variation of the first embodiment, an elongated screen artefact 920 displayed generally between an initial display location and a current screen location of reference document area during and immediately after scrolling.

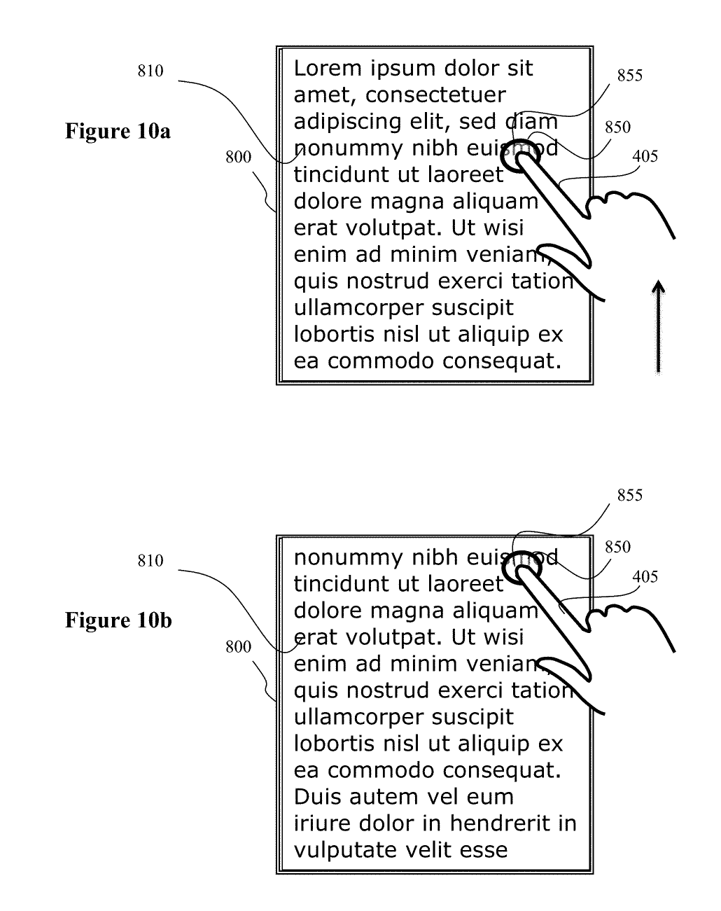

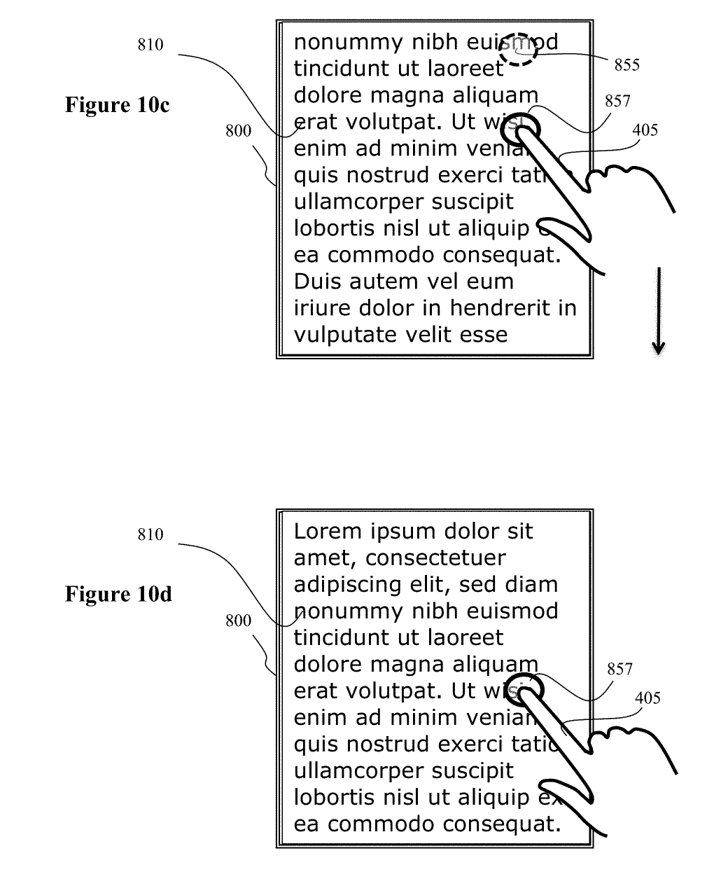

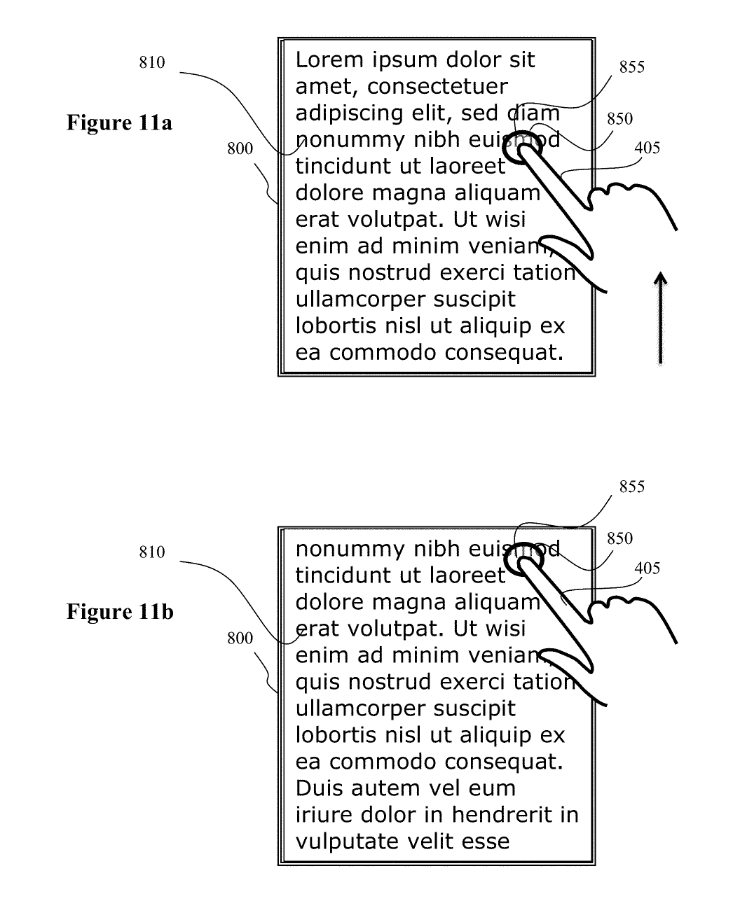

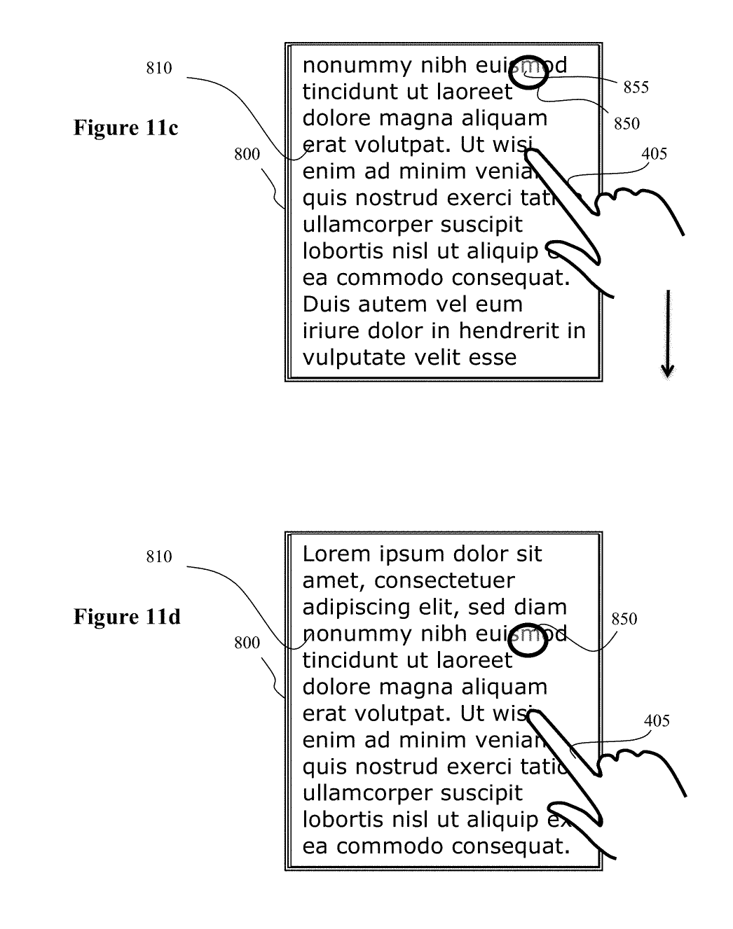

The visual cue disclosed in the present invention can be disabled when a scrolling action is completed, either immediately or after a predetermined amount of time. However, if a new scrolling action with a touchscreen display is initiated shortly after the previous scrolling action, then the visual cue from the previous scrolling action can be used instead of generating a new visual cue. This variation of the first embodiment is illustrated by FIG. 10 and FIG. 11. FIG. 10 depicts a sequence of two scrolling actions, first scrolling up and then scrolling down by generally the same distance, from generally the same location of the display, with the second scrolling action taking place after more than a predetermined amount of time after the first scrolling action is completed. The first action (FIG. 10a and FIG. 10b) produces a visual cue 850, which cue, along with its corresponding reference document area 855, moves up when the first scrolling action is performed. When the first scrolling action is completed, visual cue 850 is disabled after a certain time. The second scrolling action (FIG. 10b and FIG. 10c) produces a new visual cue 857. FIG. 11 depicts a sequence of two scrolling actions, first scrolling up and then scrolling down by generally the same distance, with the second scrolling action taking place after more than a predetermined amount of time after the first scrolling action is completed. The first action (FIG. 11a and FIG. 11b) produces a visual cue 850, which cue, along with its corresponding reference document area 855, moves up when the first scrolling action is performed. The second scrolling action (FIG. 11b and FIG. 11c) does not produce a new visual cue. Instead, visual cue 850 is moved down.

The second embodiment of the invention discloses a method and apparatus for scrolling that includes kinetic scrolling: the document continues to scroll for some time, while possibly slowing down, after user's contact with a scrolling input device is interrupted. The scrolling including kinetic scrolling can be performed by either a separate touch-sensing device, such as touchpad, or a scrolling input device integrated with a display, such as a touchscreen. The scrolling is typically performed by flicking, that is, making an initial contact with a scrolling input device, then quickly moving the contact point away from the initial contact point, and then breaking the contact with the scrolling input device, so that the direction, distance, and speed of the scrolling are determined by the direction, distance, and speed of the flicking movement.

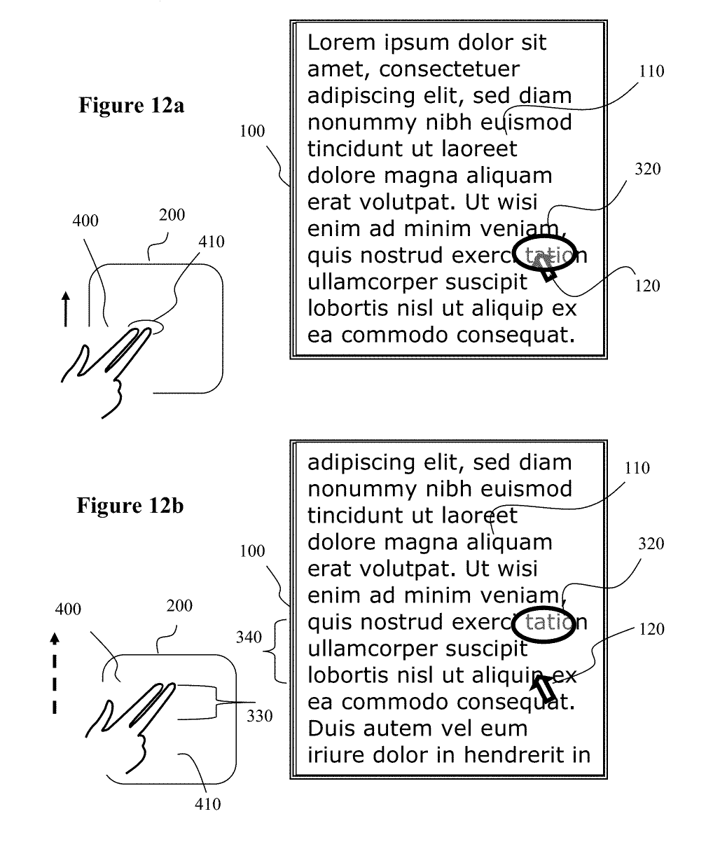

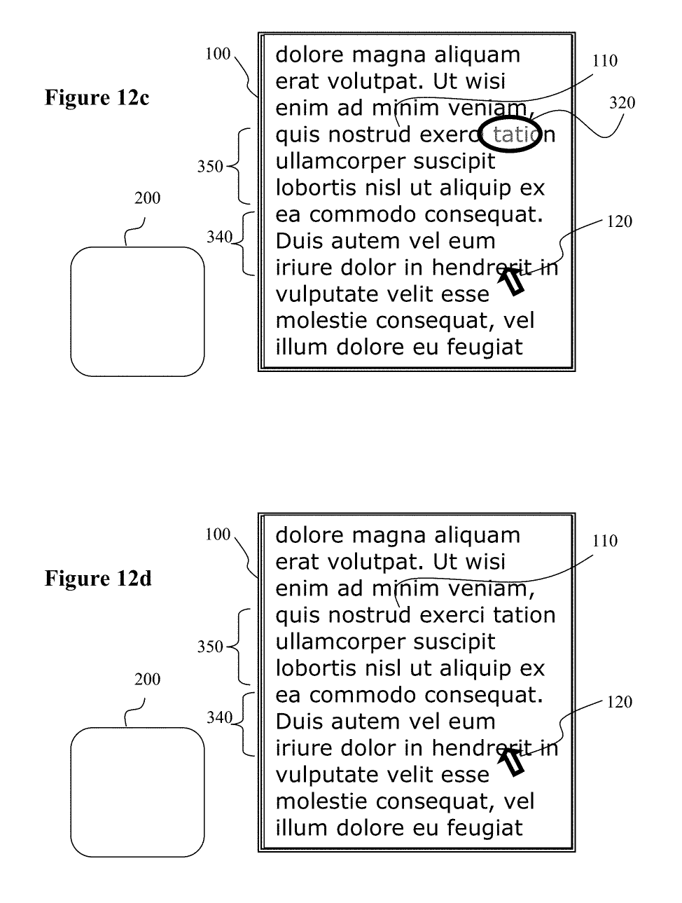

A variation of the second embodiment that involves using a separate scrolling input device is illustrated by FIG. 12. FIG. 12a shows user's fingers 400 making the initial contact with a separate touch-sensing device 200 in area 410 of device 200. A visual cue 320 is displayed in window 100 to highlight a reference document area of document 110, said clue 320 being displayed generally at the screen location of pointer 120 at the moment when the scrolling action begins. When user's fingers 400 move up for distance 330 while maintaining contact with device 200, document 110 scrolls up for distance 340 and visual cue 820 moves up for distance 440 (FIG. 12b). When user's fingers 400 break contact with device 200, document 110 additionally scrolls up for distance 350 and visual cue 820 moves up for distance 350 (FIG. 12c). Then after a predetermined amount of time visual cue 320 fades away and disappears (FIG. 12d).

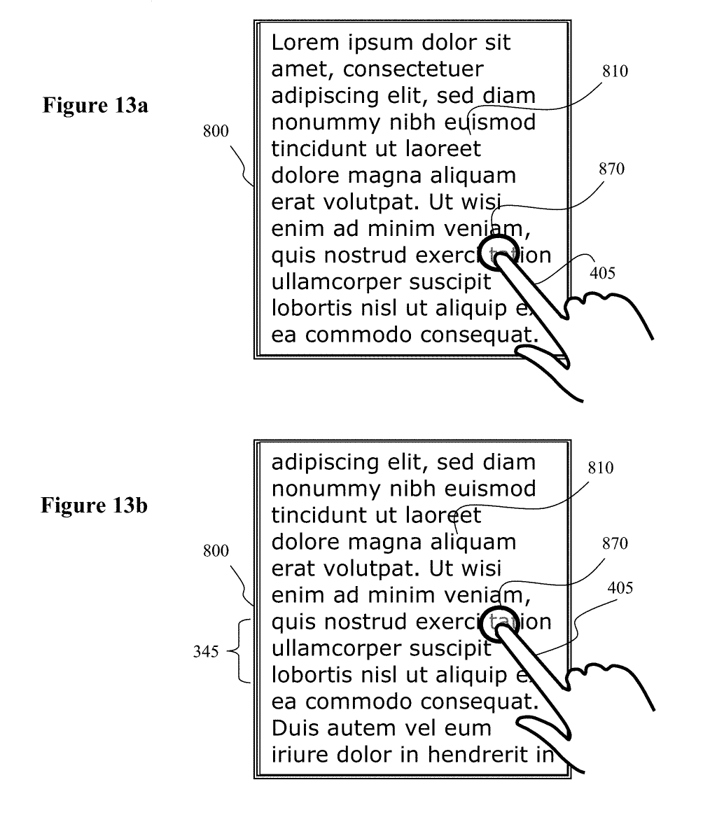

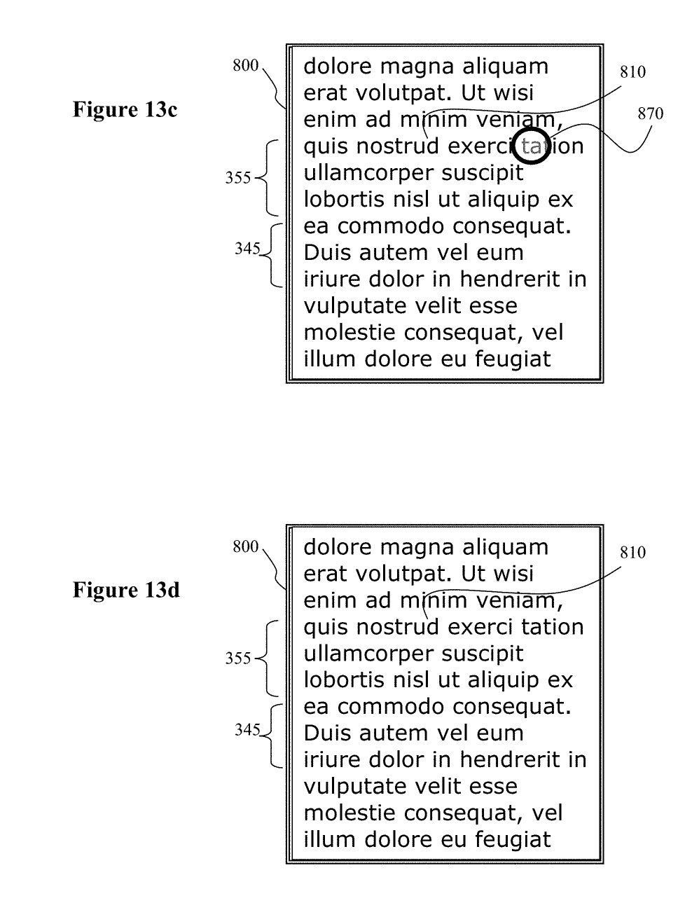

An obvious variation of the second embodiment, shown in FIG. 13, includes scrolling to a new content by performing a flicking gesture on a touchscreen. Otherwise the visual cue is used in generally the same manner as described in FIG. 12. FIG. 13a shows user's finger 405 making the initial contact with display 800. A visual cue 870 is displayed on display 800 to highlight a reference document area, which is the area of document 810 displayed at the screen location generally surrounding the contact of the finger 405 with touchscreen 810 when the user initiates the scrolling action. When user's finger 405 moves up for distance 345 while maintaining contact with display 800, document 110 also scrolls up for distance 345 and visual cue 870 moves up for distance 345 (FIG. 13b). When user's finger 405 breaks contact with display 800, document 810 additionally scrolls up for distance 355 and visual cue 870 also moves up for distance 355 (FIG. 13c). Then, after a predetermined amount of time, visual cue 870 fades away and disappears (FIG. 13d).

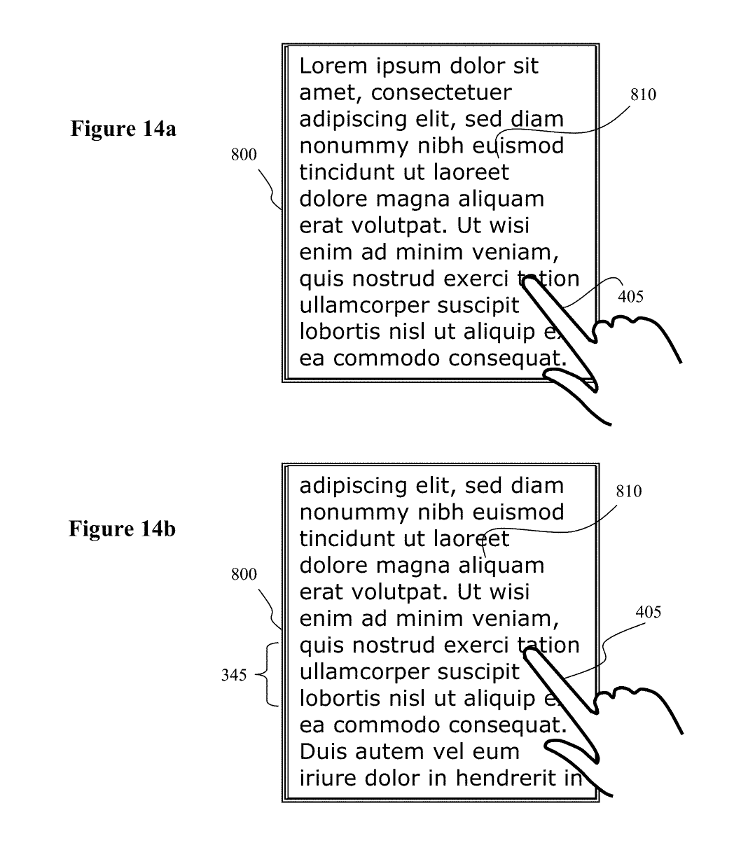

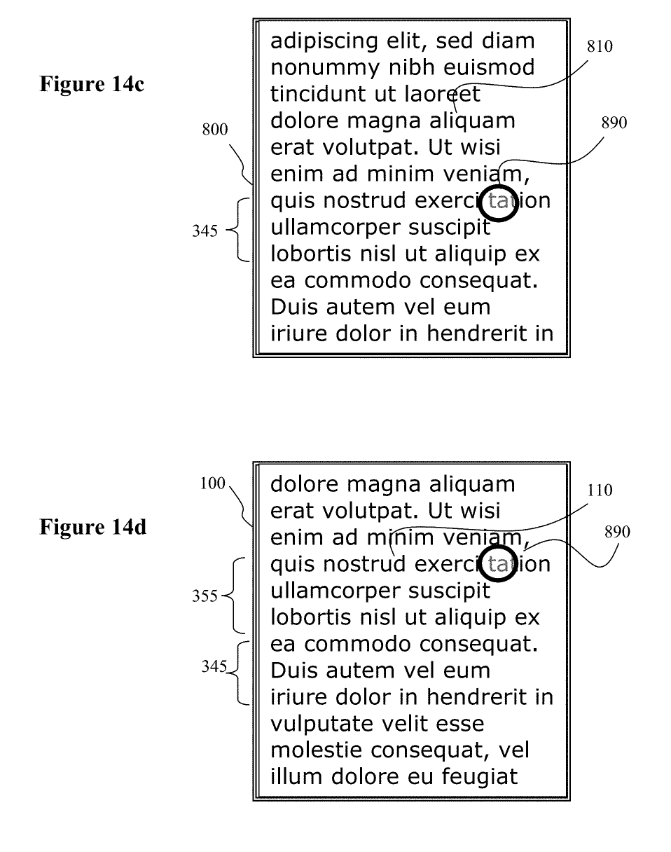

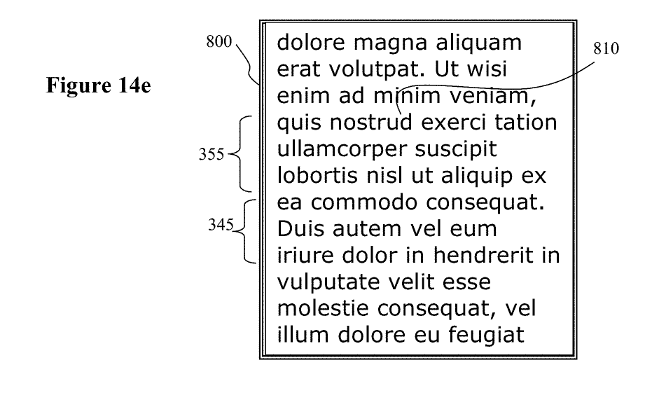

Another variation of the second embodiment is scrolling to a new content by performing a flicking gesture on a touchscreen so that the resulting scrolling includes kinetic scrolling, and a visual clue highlighting the reference document area is displayed only during the kinetic scrolling. FIG. 14a shows user's finger 405 making the initial contact with touchscreen 800; the point of contact being the initial display location. The initial display location defines a reference document area, generally in the same way as in the previously described embodiments of the invention. As opposed to previously described embodiments, however, the visual cue for highlighting the reference document area is not displayed yet. When user's finger 405 moves up for distance 345 while maintaining contact with display 800, document 110 scrolls up for distance 345, and still the visual cue for highlighting the reference document area is not displayed. When user's finger 405 breaks contact with display 800, a visual cue 890 is displayed to highlight the reference document area. Document 810 additionally scrolls up for distance 355 and visual cue 890 also moves up for distance 355 (FIG. 14d). Then after a predetermined amount of time visual cue 820 fades away and disappears (FIG. 14e). It is obvious that in the context of this particular variation of the second embodiment the reference document area can be alternatively defined as the area generally surrounding the location of user's contact with the display immediately before the contact is broken. This alternative way of defining the reference document area is possible because in the context of this variation of the second embodiment the reference document area defined by the initial display location (the initial contact of user's finger with the display, shown in FIG. 14c) is the same as the reference document area defined as an area surrounding the point of contact of the finger 405 with touchscreen 810 before the contact between finger 405 and touchscreen 810 is broken (FIG. 14c).

According to all embodiments of the invention, the size, shape, color, brightness, transparency, and other attributes of the highlighting visual cue disclosed in the invention can be defined or selected by the user. The user may also select options and preferences, including enabling or disabling the visual cue, time thresholds, types of the visual cue, and a spatial offset between screen pointer location (alternatively, user contact point when using a touchscreen device) and a visual cue. For instance, the user may prefer a visual cue to be displayed on a margin of a document rather than overlaid on the content of a document.

While the scrolling input devices illustrated by FIGS. 4-14 above are touchpad and touchscreen, it is obvious to those skilled in the art that many other types of devices can be used to perform scrolling actions, including, but limited to, scroll wheels, joysticks, trackpads, graphic tablets, are covered by the invention. In these cases the direction and distance of scrolling are determined by the parameters of the user action, such as direction, distance, time, and speed, performed on a scroll wheel or other alternative scrolling input device.

In addition, while the example of a separate scrolling input device illustrated in the description above, a touchpad, can be also be used for controlling the position of a screen pointer, it is understood that a separate scrolling input device in the context of this invention can have a more limited functionality, not including the control of a screen pointer. The use of such scrolling input devices can be combined with other devices, which can be used to control the position of a screen pointer.

Furthermore, while the figures above illustrate only one type of screen pointers, an arrow, it is understood that other types of screen pointers, including hand-shaped pointers, text cursors (e.g., short vertical or oblique lines), and so forth, are covered by the present invention.

In the context of the present invention the term “document” is understood in a broad sense, as including all kinds of information objects, viewing of which may require scrolling: text, graphics, video, maps, computer folders, computer desktops, augmented reality images, virtual reality images, computer game scenes, and so forth.

The term “display” is also understood in a broadest sense, as covering all types of digital displays and windows that can display the scrolling of information contents, including touch screens and their parts and combinations, augmented reality glasses and helmets, virtual reality glasses and helmets, in-car head up displays, and so forth.

What is claimed is:

1. A method for assisting a user of an electronic device in viewing information on said electronic device,
said electronic device having at least a processor, a memory storage, said memory storage can be integrated with said processor, a variable increment scrolling input device, a display, said display having an at least a window displaying a portion of at least a document, and means for detecting a location of said display selected through a pointing user action,
the method comprising the method steps of:
detecting a first scrolling user action; and
creating a computer memory description of a reference area of said document, said reference document area being a document area displayed at generally an initial display location, said initial display location being a location of said display selected through a pointing user action at a moment when the first scrolling user action is detected; and
scrolling said display window from a first portion of said document to a second portion of said document, wherein generally continuously providing a first visual cue for highlighting said reference document area.

2. The method of claim 1, wherein said first visual cue is disabled after a first predetermined amount of time.

3. A method of claim 1, wherein
a separate input device is used for scrolling; and
the user is provided with means for controlling a screen pointer; and
said initial display location is a screen location of a screen pointer at a moment when the first scrolling user action is detected.

4. A method of claim 3, further comprising the steps of detecting a second scrolling user action; and
if an amount of time between the first scrolling user action and the second scrolling user action is less than a second predetermined amount of time, then scrolling the display window to a third portion of said document, wherein generally continuously providing the first visual cue for highlighting said reference document area as long as said reference document area is visible in said display window, and
disabling said first visual cue after a third predetermined amount of time.

5. A method of claim 3, further comprising the step of generally continuously providing a second visual cue for highlighting a distance between said reference document area and said initial display location.

6. A method of claim 3, wherein the first visual cue is disabled by gradually fading away.

7. A method of claim 3, wherein the presence or absence, size, shape, color, and transparency of the first visual cue, as well as a spatial offset between the initial display location and the first visual cue, can be defined or selected by the user.

8. A method of claim 1, wherein a touch-sensitive display is used as a scrolling input device, and said initial display location is a screen location of user's contact with the touch-sensitive display at a moment when the first scrolling user action is detected.

9. A method of claim 9, wherein scrolling of said display window from the first portion of said document to the second portion of said document includes scrolling that temporarily continues when user's contact with the display is terminated.

10. A method of claim 8, further comprising the steps of
detecting a third scrolling user action; and
if an amount of time between the first scrolling user action and the third scrolling user action is less than a second predetermined amount of time, then scrolling the display window to a third portion of said document, wherein generally continuously providing the first visual cue for highlighting said reference document area as long as said reference document area is visible in said display window, and
disabling said first visual cue after a third predetermined amount of time.

11. A method of claim 9, further comprising the step of generally continuously providing a second visual cue for highlighting a distance between said reference document area and said initial display location.

12. A method of claim 8, wherein the first visual cue is disabled by gradually fading away.

13. A method of claim 8, wherein the presence or absence, size, shape, color, and transparency of the first visual cue, as well as a spatial offset between the initial display location and the first visual cue, can be defined or selected by the user.

14. A method of claim 9, wherein the first visual cue is not displayed when user's contact with the touchscreen display is maintained.

15. An apparatus, comprising at least
a processor; and
a memory storage, which can be integrated with said processor; and
a variable increment scrolling input device, such as a scroll wheel or a touch-sensing device; and
a display, which can be integrated with said input device, for instance, in the form of a touch-sensitive display, said display including at least a window displaying a portion of at least a document; and
software for detecting a first scrolling user action, said scrolling user action detection software stored in said memory storage; and
software for detecting a screen area of said display selected through a pointing user action; and
software for detecting an initial display location, said initial display location being an area of said display selected through a pointing user action at a moment when the first scrolling user action is detected; and
software for defining a reference document area as an area of said document displayed at generally said initial display location at the moment when the first scrolling user action is detected, said reference document area defining software stored in said memory storage; and
software for enabling the scrolling of said display from a first portion of said document to a second portion of said document, wherein generally continuously providing a first visual cue for highlighting the reference document area, said scrolling enabling software stored in said memory storage, and
software for disabling said third visual cue after a first predetermined amount of time, said visual cue disabling software stored in said memory storage.

16. An apparatus of claim 15 wherein a separate scrolling input device is used, and said initial display location is a location of a screen pointer at a moment when the first scrolling user action is detected.

17. An apparatus of claim 15 wherein a touch-sensitive display is used for perform scrolling, and said initial display location is a screen location of user's contact with the display at a moment when the first scrolling user action is detected.

18. (An apparatus of claim 15, further comprising
software for detecting a second scrolling user action, said detecting software stored in said memory storage; and
software for deciding whether the amount of time between the first user action and the second user action is less than a second predetermined amount of time, said deciding software stored in said memory storage; and
software for enabling the scrolling of said display to a second portion of said document, wherein generally continuously providing a first visual cue for highlighting the reference document area as long as said reference document area is visible on said display, said scrolling software stored in said memory storage; and
software for disabling said first visual cue after a third predetermined amount of time.
